(19) United States
(12) Patent Application Publication
(10) Pub. No.: US 2007/0073747 A1
(43) Pub. Date: Mar. 29, 2007

(54) Information Storage medium on which interactive contents version information is recorded, and recording and/or reproducing method and apparatus

(75) Inventors: Kil-soo Jung, Gyeonggi-do (KR); Jung-wan Ko, Gyeonggi-do (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/604,327

(22) Filed: Nov. 27, 2006

Related U.S. Application Data
(62) Division of application No. 10/414,302, filed on Apr. 16, 2003.

(30) Foreign Application Priority Data
Apr. 16, 2002 (KR) 2002-20597
Nov. 21, 2002 (KR) 2002-72838

(51) Int. Cl. G06F 7/00

(52) U.S. Cl. 707/100

(57) ABSTRACT

An information storage medium on which interactive contents version information is recorded, a recording and reproducing method, and a recording and/or reproducing apparatus include minimum markup version information and minimum multimedia version information. Since a markup document can be displayed in a reproducing apparatus having a viewer version lower than a specification version of an authoring tool used to author the markup document. If the specification version of the authoring tool is higher than a viewer version supported by the reproducing apparatus, interactive contents may not be correctly reproduced due to specification version information automatically written in the markup document using the authoring tool. Since the information storage medium includes the minimum interactive contents version information and/or the minimum multimedia version information that can be reproduced by the reproducing apparatus, the reproducing apparatus can reproduce the interactive contents smoothly.

### CROSS-REFERENCE TO RELATED APPLICATIONS

This application is a divisional of U.S. Pat. application Ser. No. 10/414,302, filed Apr. 16, 2003, now pending, and claims priority of Korean Patent Application Nos. 2002-20597, filed on Apr. 16, 2002, and 2002-72838, filed on Nov. 21, 2002, in the Korean Intellectual Property Office, the disclosures of which are incorporated herein in its entirety by reference.

### BACKGROUND OF THE INVENTION

1. Field of the Invention

The present invention relates to interactive contents information storage media, and more particularly, to an information storage medium on which minimum markup version information and/or minimum multimedia version information that can be reproduced by a reproducing apparatus supporting an interactive presentation mode is recorded, a recording and reproducing method, and a recording and reproducing apparatus.

2. Description of the Related Art

Recently, interactive digital versatile discs (DVDs) that can be reproduced in an interactive presentation mode on a personal computer (PC) have been proposed. The interactive. DVDs are DVDs on which a markup language document (hereinafter, referred to as a markup document) is recorded together with audio and/or video (AV) data. The AV data recorded on the interactive DVDs can be reproduced in two ways: in a video mode in which the reproduced AV data are displayed in the same way as data recorded on a conventional DVD, and in an interactive mode in which the reproduced AV data are displayed in a display window defined by the markup document. If the interactive mode is selected by a user, a viewer (user agent) installed in a DVD reproducing apparatus parses the markup document recorded on the interactive DVD. The AV data selected by the user are displayed in the display window of the markup document. An HTML document is a typical markup document.

Contents (hereinafter, referred to as interactive contents) of the markup document for a conventional interactive presentation mode are shown in the following Examples 1 and 2.

### EXAMPLE 1

```
<!DOCTYPE HTML PUBLIC “-//W3C//DTD HTML 3.2//EN”>
<html>
<head>
  <title>HTML 3.2</title>
  <meta name=“generator” content=“name of Authoring Tool”>
  <meta http-equiv=“Content-Type”content=“text/html;charset=EUC-KR”>
</head>
<body>
  ...
</body>
</html>
```

### EXAMPLE 2

```
<!DOCTYPE HTML PUBLIC “-//W3C//DTD HTML 4.01
Transitional//EN”>
<html>
<head>
  <title>HTML 4.01 Transitional</title>
  <meta name=“generator” content=“name of Authoring Tool”>
  <meta http-equiv=“Content-Type”content=“text/html;charset=EUC-KR”>
</head>
<body>
  ...
</body>
</html>
```

As shown in Examples 1 and 2, a specification version of the interactive contents based on a markup language is declared by describing a document type DOCTYPE in an initial part of each markup document.

Also, due to the gathering of various multimedia elements (i.e., image files, flash files, and moving image files), the interactive contents stored on the information storage medium are displayed in the display window of the markup document in various formats. These formats have their respective versions. A function of the viewer is to comprehend these versions, to parse formats corresponding to the versions, and to display the markup document on a screen of a display. The viewer is installed in the DVD reproducing apparatus reproducing the interactive contents stored in the information storage medium. Unlike in a PC, it is very inconvenient to upgrade the viewer installed in other types of home electronic devices. Thus, the interactive contents included in the information storage medium that can be reproduced in the home electronic devices should be of a version that can be recognized by the viewer so that they can be correctly reproduced. However, in a current interactive presentation mode based on the PC, when a format of the interactive contents is continuously improved to result in a frequent introduction of new upgraded format versions, the version of viewers that can interpret and display each format version must also be upgraded. Under these circumstances, in order to smoothly reproduce the interactive contents in the home electronic devices, the following problems should be considered: a problem caused by a markup language version, and a problem caused by a variety of formats of multimedia elements contained in the markup document.

First, the problem caused by the markup language version is as follows. The interactive contents to be stored in the information storage medium are formed in a graphic user interface (GUI) environment using an authoring tool. As the version of the markup language is updated, the authoring tool is improved to write the interactive contents in an upgraded version of the markup language. Thus, an author authors the interactive contents using the authoring tool that uses a higher version markup language than a viewer version supported by the DVD reproducing apparatus. The markup document authored by the above procedure can sometimes be reproduced in the DVD reproducing apparatus that supports only a previous old version, i.e., the viewer version. If a specification version, e.g., the higher version markup language, of the authoring tool is higher than the viewer version supported by the DVD reproducing apparatus due to the specification version information which has been automatically written in the markup document using the authoring tool, the interactive contents may not be correctly reproduced.

Next, the problem caused by the variety of the formats of the multimedia elements formulated in the markup language is as follows. Many markup documents presented in a current web environment are formed by adding text files using the markup language and various multimedia elements (referred to as resource files), e.g., image files, such as joint picture-experts groups (JPEGs), graphic image files (GIFs), and flash files having an extension format, such as an SWF format. These elements have version information themselves. For example, in a case of the flash files having a current version 6.0 (referred to as MX) like the markup documents, the flash files having a lower version can be reproduced by the DVD reproducing apparatus having an upper version, but the flash files having the upper version cannot be reproduced by the DVD reproducing apparatus having the lower version. Thus, even though the specification version of the markup language is the same as the viewer version of the viewer installed in the home electronic devices, if a specification version of the flash files included in the markup document is higher than the viewer version of the viewer installed in the home electronic devices, the flash files cannot be correctly reproduced. Accordingly, even if the author authors the flash files that can be recognized by a lower version viewer using an upper version flash editor, the flash files cannot be reproduced by the DVD reproducing apparatus that has the lower version lower than the upper version of the flash files.

### SUMMARY OF THE INVENTION

The present invention provides an information storage medium which stores minimum markup version information indicating a minimum version of a markup language supported by a reproducing apparatus supporting an interactive presentation mode, a recording and reproducing method and a recording and reproducing apparatus.

The present invention further provides an information storage medium which stores specification version information declared using an authoring tool in a reproduction control information file in an interactive presentation mode, and minimum user agent (UA, viewer) version information indicating a minimum version with which a UA can interpret a markup document, a recording and reproducing method, and a recording and/or reproducing apparatus.

The present invention still further provides an information storage medium in which minimum UA version information of a viewer (user agent) supporting minimum markup version information that can be reproduced by a reproducing apparatus, is added to reproduction control information data to support an interactive presentation mode, a recording and reproducing method, and a recording and/or reproducing apparatus.

The present invention still yet further provides an information storage medium in which minimum viewer version information indicating a minimum version of a viewer with which multimedia elements can be smoothly reproduced is added to interactive contents, a recording and reproducing method, and a recording and/or reproducing apparatus.

Additional aspects and advantages of the invention will be set forth in part in the description which follows and, in part, will be obvious from the description, or may be learned by practice of the invention.

According to an aspect of the present invention, an information storage medium encoded with data readable by a computer to implement a method of reproducing data from the information storage medium in an interactive presentation mode includes AV data including audio data and/or video data, a markup document in which a display window in which the AV scene, which is obtained from the AV data, and a markup document scene, which is obtained form the markup document, are displayed is defined, and minimum interactive contents version information that can be reproduced by a reproducing apparatus and used to interpret the markup document in a minimum interactive contents version.

It is possible that the minimum interactive contents version information is stored in a reproduction control information file of the markup document and in a management information table of the reproduction control information file in the markup document.

According to another aspect of the present invention, an information storage medium includes AV data including audio data and/or video data, a markup document in which a display window in which the AV scene, which is obtained from the AV data, and a markup document scene, which is obtained form the markup document, are displayed is defined. The markup document includes specification version information of the markup document and minimum user agent (UA) version information for interpreting the markup document.

It is possible that the medium further includes version information on multimedia elements in the markup document and minimum viewer version information indicating the minimum version of a viewer that can reproduce the multimedia elements.

According to another aspect of the present invention, an information storage medium includes AV data including audio data and/or video data, a markup document in which a display window in which the AV scene, which is obtained from the AV data, and a markup document scene, which is obtained form the markup document, are displayed is defined, and minimum markup version information and/or minimum multimedia version information that can be reproduced by a reproducing apparatus.

It is possible that the minimum markup version information and the minimum multimedia version information are stored in a reproduction control information file in the markup document. It is also possible that the minimum multimedia version information is stored in a tag <META> in the markup document.

According to another aspect of the present invention, a recording method includes recording audio and/or video (AV) data, and recording a markup document in which a display window in which the AV data is displayed is defined, and recording specification version information of the markup document and minimum interactive contents version information that can be reproduced by a reproducing apparatus in the markup document.

According to another aspect of the present invention, a recording method includes recording audio and/or video (AV) data, recording a markup document in which a display window in which the AV data is displayed is defined, and recording minimum markup version information and/or minimum multimedia version information that can be reproduced by a reproducing apparatus.

According to another aspect of the present invention, a method of reproducing AV data recorded on an information storage medium in an interactive presentation mode includes reading specification version information of a markup document to be reproduced together with the AV data and minimum interactive contents version information that can be reproduced by a reproducing apparatus from the information storage medium, and even if the specification version information of the markup document is higher than version information of a reproducing apparatus reading the information storage medium, interpreting and displaying the markup document according to the minimum interactive contents version information.

It is possible that the method further includes determining whether multimedia elements other than text files exist in the markup document, and if the multimedia elements exist in the markup document, checking a current version of the multimedia elements in the markup document and a minimum viewer version that can reproduce the multimedia elements, and reproducing the multimedia elements according to a result of checking the current version of the multimedia.

According to another aspect of the present invention, a method of reproducing AV data recorded on an information storage medium in an interactive presentation mode includes determining whether multimedia elements other than text files exist in a markup document to be reproduced together with the AV data read from the information storage medium, and if multimedia elements exist in the markup document, checking a current version of the multimedia elements in the markup document and a minimum viewer version that can reproduce the multimedia elements, and reproducing the multimedia elements according to a result of checking the current version of the multimedia elements.

According to another aspect of the present invention, a recording apparatus includes recording unit recording audio and/or video (AV) data on an information storage medium, and recording a markup document defining a display window in which the AV data is displayed, and recording specification version information of the markup document and minimum interactive contents version information that can be reproduced by a reproducing apparatus in the markup document, on the information storage medium.

According to another aspect of the present invention, a recording apparatus includes a recording unit recording audio and/or video (AV) data, recording a markup document defining a display window in which the AV data is displayed on an information storage medium, and recording minimum markup version information and/or minimum multimedia version information that can be reproduced by a reproducing apparatus.

According to another aspect of the present invention, a reproducing apparatus reproducing AV data recorded on an information storage medium in an interactive presentation mode includes a reader reading specification version information of a markup document to be reproduced together with the AV data and minimum interactive contents version information that can be reproduced from the information storage medium, and a controller interpreting and displaying the markup document according to the minimum interactive contents version information when the specification version information of the markup document is higher than version information of the reproducing apparatus reading the information storage medium.

According to another aspect of the present invention, a reproducing apparatus reproducing AV data recorded on an information storage medium in an interactive presentation mode includes a reader reading a markup document having multimedia elements from the information storage medium, and a controller determining whether multimedia elements other than text files exist in a markup document to be reproduced together with the AV data read from the information storage medium, and upon determining that multimedia elements exist in the markup document, checking a current version of the multimedia elements in the markup document and a minimum viewer version that can reproduce the multimedia elements, and reproducing the multimedia elements according to the result of the checking.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a block diagram of a reproducing apparatus according to an embodiment of the present invention;

FIG. 2 shows an example of a structure of a directory of an information storage medium supporting an interactive presentation mode in the reproducing apparatus shown in FIG. 1;

FIG. 3 shows another example of the structure of the directory of the information storage medium supporting the interactive presentation mode in the reproducing apparatus shown in FIG. 1;

FIGS. 4A and 4B are reference diagrams illustrating an interactive presentation mode in the reproducing apparatus shown in FIG. 1;

FIG. 5 shows an example of contents and a structure of a reproduction control information file for the interactive presentation mode in which interactive contents version information is recorded, in the reproducing apparatus shown in FIG. 1;

FIG. 6 is a flowchart illustrating a recording method according to an embodiment the present invention;

FIG. 7 is a flowchart illustrating another reproducing method in the reproducing apparatus shown in FIG. 1; and

FIG. 8 shows a flowchart illustrating another reproducing method in the reproducing apparatus shown in FIG. 1.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described in order to explain the present invention by referring to the figures.

The meanings of certain terms used in the description are as follows. A markup document represents a document written in a markup language, such as HTML or XML, a script language (i.e., JavaScript), or an execution code (i.e., Java Applet), including a source code or an execution code linked to the document or inserted into the document. The markup document further includes all files linked to or inserted into the markup document and used to display a screen. That is, the markup document may be a kind of application required to reproduce AV data in an interactive presentation mode. Minimum interactive contents version information represents minimum version information of the markup document that can be reproduced by a reproducing apparatus in which a user agent (UA), such as a viewer or browser, is installed.

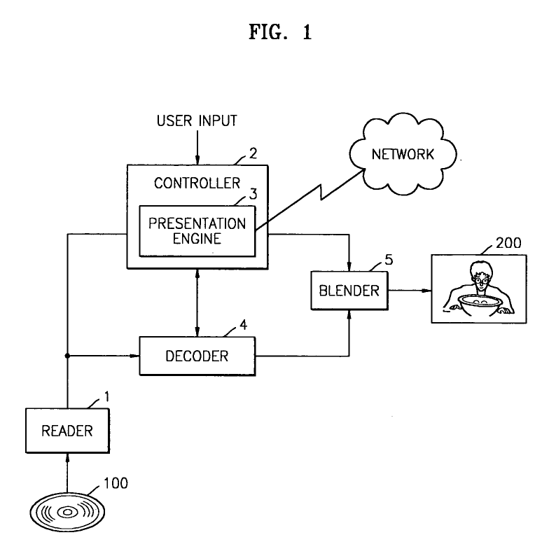

FIG. 1 is a block diagram of a reproducing apparatus according to an embodiment of the present invention. Referring to FIG. 1, the reproducing apparatus includes a reader 1, a controller 2, a decoder 4, and a blender 5. A presentation engine 3 is installed in the controller 2.

The reader 1 reads AV data, a markup document, and reproduction control information from a disc (medium) 100, that is, an interactive DVD. The controller 2 controls the presentation engine 3, the decoder 4, and the blender 5 so that the AV data, the markup document, and the reproduction control information are reproduced in a representative video mode or an interactive presentation mode according to a user input.

The presentation engine 3 is an interpretation engine which interprets and executes a client interpretation program language such as JavaScript, Java, ASP, and PHP. Further, the presentation engine 3 includes plug-in applications. The plug-in applications allow a user to download files in a variety formats included in or linked to the markup document. In the interactive presentation mode, the presentation engine 3 brings the markup document from a predetermined node of a network, interprets the markup document and checks a location of a display window in which an AV data stream output from the decoder 4 is displayed. The blender 5 blends the AV data stream with the interpreted markup document and displays an AV scene and a markup document scene together in a display 200 connected to the reproducing apparatus so that the decoded AV data stream is displayed in the display window defined by the markup document, that is, so that the AV scene is embedded in the markup document scene.

In particular, the presentation engine 3 seeks a reproduction control information file for the markup document read by the reader 1 and checks whether a specification version of the markup document declared using an authoring tool when an initial document of the markup document is authored in the reproduction control information file of the markup document during encoding data to form the AV data, the markup document, and the reproduction control information in the disc 100, is higher than a viewer version supported by a viewer or user agent (UA) in the reproducing apparatus. If the specification version is higher than the viewer version supported by the user agent (UA), the presentation engine 3 reads minimum interactive contents version information from the reproduction control information file of the markup document. If a minimum interactive contents version of the read minimum interactive contents version information is higher than the viewer version supported by the UA in the current reproducing apparatus, the presentation engine 3 displays an alarm message indicating that the presentation engine 3 cannot support the reproduction of the disc 100 installed in the current reproducing apparatus, on the display 200. On the other hand, if the specification version declared using the authoring tool is not higher than the version supported by the UA in the current reproducing apparatus, or the minimum interactive contents version is not higher than the version supported by the UA in the current reproducing apparatus, the presentation engine 3 reads the markup document through the reader 1 and interprets and executes a markup language read from the markup document.

Also, the presentation engine 3 determines whether multimedia elements excluding text files exist in the markup document, checks a current version of only multimedia elements that exist in the reproduction control information file or are used as interactive contents defined using tag <META> in tag <HEAD> in the markup document, and also checks minimum viewer information in which the multimedia elements can be smoothly reproduced. The presentation engine 3 determines whether the current version of the multimedia elements in tag <META> is higher than the viewer version of the viewer (user agent, UA) installed in the reproducing apparatus. If the current version of the multimedia elements is higher than the viewer version of the viewer installed in the reproducing apparatus, the presentation engine 3 determines whether a minimum viewer version that can reproduce the multimedia elements is higher than the viewer version of the viewer installed in the reproducing apparatus. If the minimum viewer version that can reproduce the multimedia elements is higher than the viewer version of the viewer installed in the reproducing apparatus, the presentation engine 3 reproduces replacement elements (character or graphic messages) in a layout area corresponding to the multimedia elements. If the current version of the multimedia elements is not higher than the viewer version of the viewer installed in the reproducing apparatus or the minimum viewer version that can reproduce the multimedia elements is not higher than the viewer version of the viewer installed in the reproducing apparatus, the presentation engine 3 interprets and executes the corresponding multimedia elements.

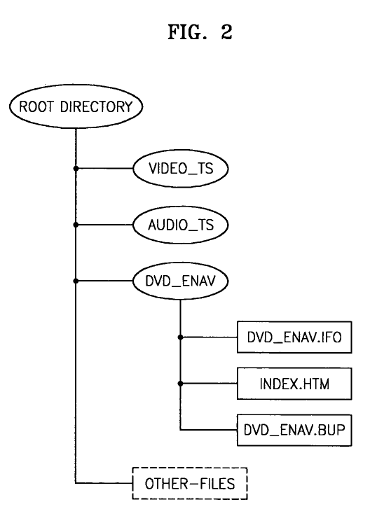

FIG. 2 shows an example of a structure of a directory of an information storage medium, such as the disc (medium) 100, supporting the interactive presentation mode of the reproducing apparatus shown in FIG. 1. Referring to FIG. 2, a video directory VIDEO_TS in which the AV data are included, an audio directory AUDIO_TS in which audio data is included, and an interactive presentation directory DVD_ENAV in which information for supporting the interactive presentation mode is included, are provided in a root directory. Here, the audio directory AUDIO_TS may not exist separately from the video directory VIDEO_TS but is combined with the video directory VIDEO_TS.

Meanwhile, the reproduction control information file DVD_ENAV.IFO for the markup document is recorded in the interactive presentation directory DVD_ENAV. For example, a definition and a structure of a corresponding directory, the number of titles, basic information on titles, information on languages used in the titles, sub-titles, and fonts, markup document display information, such as resolution and colors, copyright information, and text information authored by a contents author are recorded in the reproduction control information file DVD_ENAV.IFO. Further, an index document INDEX.HTM to be displayed together with video titles, a backup file DVD_ENAV.BUP of the reproduction control information file DVD_ENAV.IFO, and other markup documents are stored in the interactive presentation directory DVD_ENAV. A file inserted in the markup document and displayed together with the video titles, such as the index document INDEX.HTM, may also be stored in the interactive presentation directory DVD_ENAV.

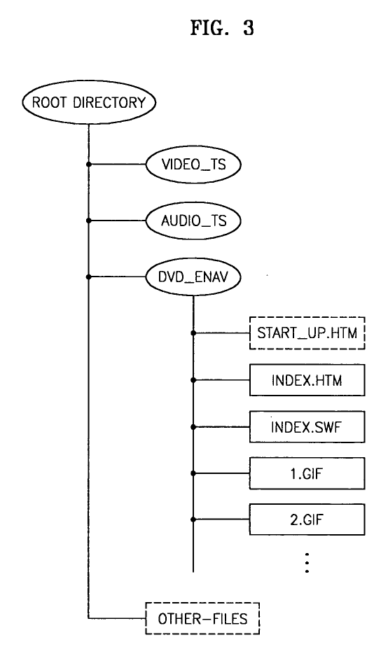

FIG. 3 shows another example of the structure of the directory of the information storage medium for supporting the interactive presentation mode of the reproducing apparatus shown in FIG. 1. Referring to FIG. 3, the structure of the directory shown in FIG. 3 is the same as the structure of the directory shown in FIG. 2 in that the video directory VIDEO_TS in which the AV data are included, the audio directory AUDIO_TS in which the audio data is included, and the interactive presentation directory DVD_ENAV in which information for supporting the interactive presentation mode is included, are provided in the root directory. However, the reproduction control information file DVD_ENAV.IFO for the markup document is not recorded in the interactive presentation directory DVD_ENAV, whereas an index document INDEX.HTM to be displayed together with the video titles, a flash file INDEX.SWF, and graphic files 1.GIF and 2.GIF is recorded in the interactive presentation directory DVD_ENAV.

Since the reproduction control information file DVD_ENAV.IFO for the markup document is not recorded in the directory DVD_ENAV, in order to perform the same function as the reproduction control information file DVD_ENAV.IFO, a document START_UP.HTM may be stored in the directory DVD_ENAV to interpret a screen ratio of the reproducing apparatus and an aspect ratio of an authored markup document before files in the directory DVD_ENAV are executed, and to properly pre-load the files stored in the directory DVD_ENAV based on results of the interpretation, although the document START_UP.HTM is not displayed on a screen of the display 200.

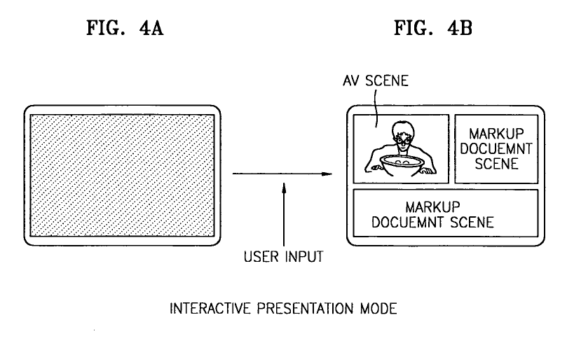

FIGS. 4A and 4B are reference diagrams illustrating the interactive presentation mode of the reproducing apparatus shown in FIG. 1. Referring to FIGS. 4A and 4B, if the user installs the interactive DVD in the reproducing apparatus, the interactive presentation mode is selected in a menu screen displayed on the display 200 such as a television or monitor. When the interactive DVD has the structure shown in FIG. 2, the reproducing apparatus reads the reproduction control information file DVD_ENAV.IFO for the markup document recorded on the DVD, interprets the reproduction control information file DVD_ENAV.IFO, reads the index document INDEX.HTM designated as a startup document and reproduces corresponding ones of the video titles based on the read index document INDEX.HTM. Also, since the reproduction control information file DVD_ENAV.IFO is linked to the index document INDEX.HTM, when the resolution of the screen and the languages of language information displayed in the markup document scene are changed, the reproducing apparatus may move to another index document INDEX.HTM through the reproduction control information file DVD_ENAV.IFO, read the index document INDEX.HTM and reproduce the corresponding video titles based on the read another index document INDEX.HTM.

As a result, a state in which nothing is displayed on the display 200 shown in FIG. 4A, is changed, into the interactive presentation mode in which the AV scene, in which video titles are reproduced, and the markup document scene, in which a markup document (i.e., HTML) is reproduced, are displayed together on the display 200 as shown in FIG. 4B. Here, the AV scene represents a scene in which the AV data are reproduced and displayed, and the markup document scene represents a scene in which the markup document is reproduced and displayed. For example, when the AV data is a movie, a moving image is output in the display window of the markup document, and various additional information including scenario, history, and actors' pictures related to the movie are displayed in a remaining part of the screen excluding the display window of the markup document. The additional information includes image or text files.

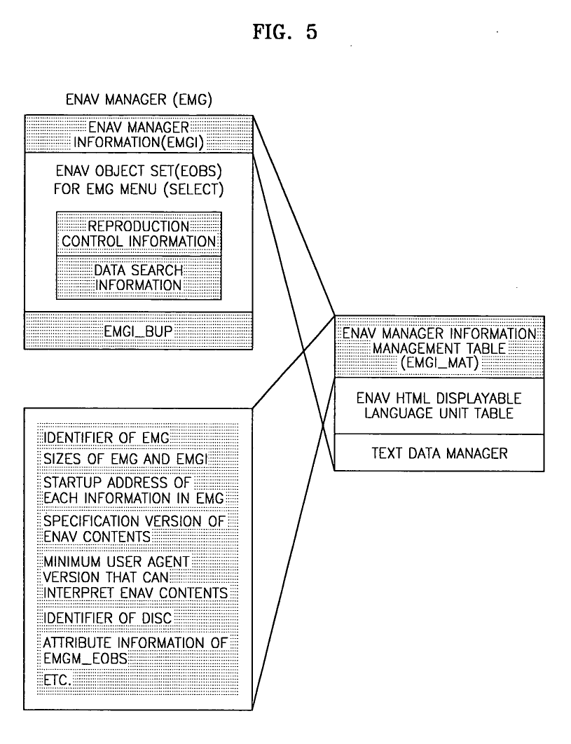

FIG. 5 shows an example of contents and a structure of the reproduction control information file for the interactive presentation mode, in which interactive contents version information is recorded, performed in the reproducing apparatus shown in FIG. 1. In other words, FIG. 5 shows the contents and the structure of reproduction control information stored in the reproduction control information file DVD_ENAV.IFO in the interactive presentation directory DVD_ENAV shown in FIG. 2.

Referring to FIG. 5, an ENAV manager (EMG), in which the contents of the reproduction control information file DVD_ENAV.IFO for the markup document is described, includes ENAV manager information (EMGI) in which search information of the markup document or information on an initial access, reproduction information of the EMG, and a text data information are described, an ENAV object set (EOBS) for an EMG menu in which reproduction control information and data search information are stored, and a backup file EMGI_BUP of the EMGI.

The EMGI may include an ENAV manager information management table (EMGI_MAT), an ENAV HTML displayable language unit table which designates a type of displayable languages of the markup document, and a text data manager.

An identifier of the EMG, sizes of the EMG and the EMGI, a startup address of each piece of information in the EMG, a specification version of ENAV contents, a minimum version of the user agent (UA) which interprets the ENAV contents for implementing the present invention, an identifier of the disc 100, and attribute information of an ENAV object set EMGM_EOBS for the EMG menu are provided in the EMGI_MAT.

The minimum interactive contents version information is provided in the EMGI_MAT of the EMGI as the following field name. The minimum interactive contents version information has a form of PRS_UA_VERN and a size of 2 bytes. For example, if the minimum version number of the UA which can interpret the markup document is “0×10”, the version which can be interpreted by the UA, represents a markup language specification version 1.0.

Meanwhile, like as the markup language, minimum viewer version information indicating that the multimedia elements can be reproduced by the reproducing apparatus, may be added to the reproduction control information file for supporting the interactive presentation mode. The minimum viewer version information may be added to the reproduction control information file DVD-ENAV.IFO using tag <META> in tag <HEAD> in a markup document. This is because, in the case of the markup language, the viewer installed in the reproducing apparatus cannot interpret the markup language from an initial part of the markup document authored in a version higher than the viewer version of the viewer, and thus, markup language version information is added to reproduction control information data (the reproduction control information file DVD-ENAV.IFO) that does not have a relationship with the markup language. But, in a case of the multimedia elements included in the markup document, version information on the multimedia elements is significant only when the markup document can be interpreted by the viewer installed in the reproducing apparatus without storing the version information on the multimedia elements in the reproduction control information data, and thus, the version information thereon may use the tag <META> which serves to provide information in the markup document. An example of the use of the tag <META> is shown below.

### EXAMPLE 3

```
<?XML version=“1.0”>
<html>
<head>
  <TITLE>Example</TITLE>
  <META NAME=“Flash_Version” CONTENT=“6.0;
  MinimumVersion 5.0”>
  <META NAME=“DiscID” CONTENT=⊚BCD”>
</head>
<body>
...
</body>
</html>
```

In the Example 3, even though a flash file included in the markup document is authored in a version 6.0, information that can be reproduced by the reproducing apparatus having the viewer supporting a version 5.0, that is, minimum viewer version information Minimum Version 5.0, that can reproduce the multimedia elements is added to the markup document, thereby providing a smooth reproduction environment to the reproducing apparatus.

A method of recording and reproducing information on/from an information storage medium having the above structure will be described below.

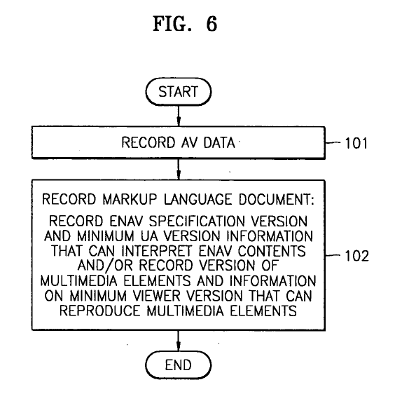

FIG. 6 is a flowchart illustrating a recording method according to an embodiment of the present invention. Referring to FIGS. 2, 4, and 6, in operation 601, a recording apparatus records AV data on an information storage medium. In operation 602, the recording apparatus records the markup document to be reproduced together with the AV data on the information storage medium. In doing so, the recording apparatus also records the specification version of the interactive contents and the information on the minimum version of the UA that can interpret the interactive contents, that is, the minimum interactive contents version information, on the ENAV manager information (EMGI) in the reproduction control information file DVD_ENAV.IFO shown in FIGS. 2 and 4.

Meanwhile, if the multimedia elements exist in the markup document, in operation 602, the recording apparatus further records the specification version of the multimedia elements and minimum viewer version information for the multimedia elements, that is, minimum multimedia elements version information, in the reproduction control information file DVD_ENAV.IFO. If the markup document including the multimedia elements has the structure of the directory shown in FIG. 2, the version of the multimedia elements and the minimum viewer version information can be stored in the reproduction control information file DVD-ENAV.IFO. If the markup document including the multimedia elements has the structure of the directory shown in FIG. 3, the version of the multimedia elements and the minimum viewer version information can be stored in the tag <META> in the markup document.

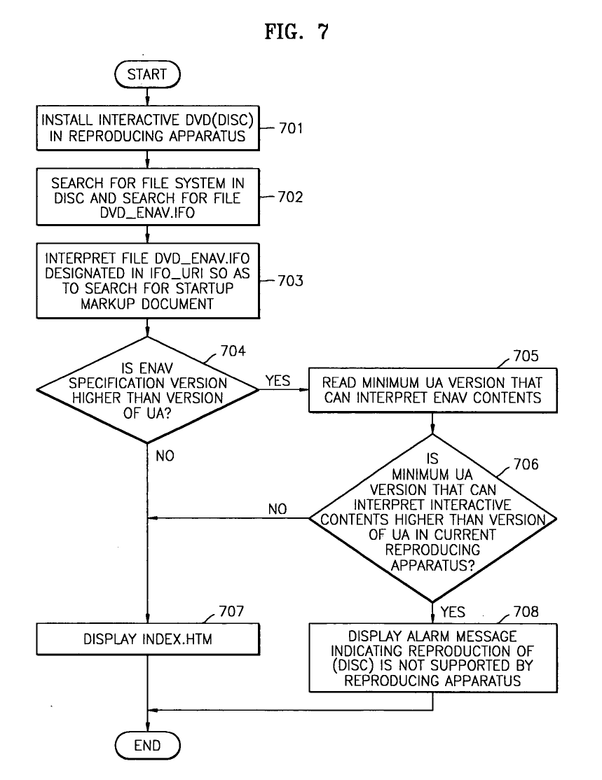

FIG. 7 is a flowchart illustrating a reproducing method, which can be applied to a case where the interactive contents having the structure of the directory shown in FIG. 2 are reproduced in the reproducing apparatus shown in FIG. 1.

Referring to FIGS. 1, 2, 3, 5, and 7, in operation 701, if the disc 200, such as the interactive DVD, is installed in the reproducing apparatus, the presentation engine 3 of the reproducing apparatus searches for a file system in the and searches for the reproduction control information file DVD_ENAV.IFO for the markup document in operation 702. Here, after operation 701 is performed, the reproducing method may further include an additional operation of setting the interactive presentation mode or the interactive presentation mode between operations 701 and 703 as a default mode by a user or automatically.

In operation 703, the reproduction control information file DVD_ENAV.IFO designated in an IFO_URI (uniform resource identifier) in which a unique address for representing a resource to execute the startup markup document is stored, is interpreted. In operation 704, the specification version of the interactive contents, that is, the specification version of the markup document automatically written by an authoring tool authoring corresponding contents, is checked.

Here, in the related art, if the specification version of interactive contents is higher than the viewer version supported by the UA in the reproducing apparatus, the reproducing apparatus cannot correctly display the markup document scene intended by an author. However, according to the present invention, since the minimum viewer version information for interpreting corresponding interactive contents is additionally recorded in the reproduction control information file DVD_ENAV.IFO as shown in FIG. 5, the reproducing apparatus can reproduce the corresponding interactive contents.

That is, in operation 705, if the specification version of the interactive contents is higher than the viewer version of the UA in the reproducing apparatus, the minimum viewer version that can interpret the interactive contents is read from the reproduction control information file DVD_ENAV.IFO. In operation 706, it is checked whether the minimum viewer version that can interpret the interactive contents is higher than the viewer version of the UA in the current reproducing apparatus. If the minimum viewer version that can interpret the interactive contents is not higher than the view version of the UA in the current reproducing apparatus in operation 706, the index document INDEX.HTM to be displayed together with the video titles is displayed in operation 707. In operation 708, if the minimum viewer version that can interpret interactive contents is higher than the viewer version of the UA in the current reproducing apparatus, the alarm message indicating that the reproduction of the medium (200) disc installed in the reproducing apparatus is not supported by the reproducing apparatus, is displayed on the display 200. Meanwhile, if the specification version of the interactive contents is not higher than the viewer version of the UA in the current reproducing apparatus in operation 704, displaying the index document INDEX.HTM is performed in the operation 707.

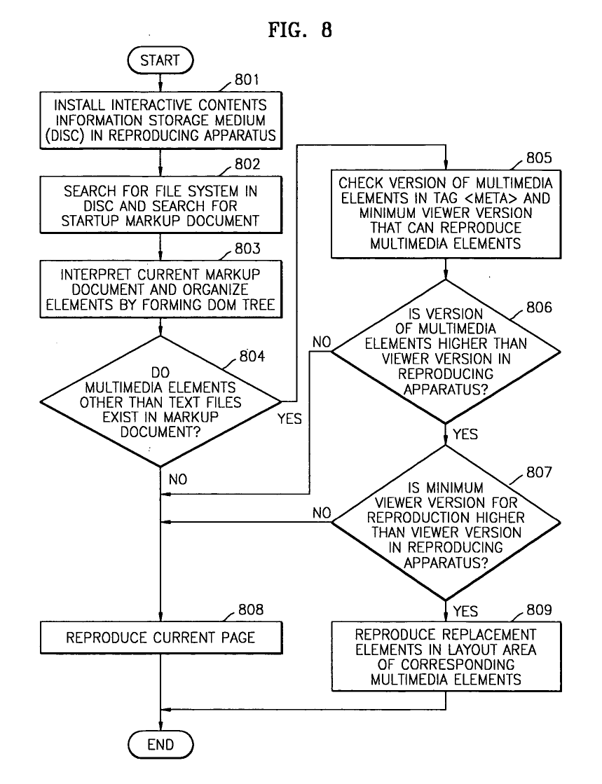

FIG. 8 is a flowchart illustrating another reproducing method, which can be applied to a case where the markup document including the multimedia elements having the structure of the directory shown in FIG. 3 is reproduced in the reproducing apparatus shown in FIG. 1.

Referring to FIGS. 1, 2, 3, 5 and 8, in operation 801, the interactive contents information storage medium (disc) 200 is installed in the reproducing apparatus. In operation 802, the presentation engine 3 in the reproducing apparatus searches for the file system in the disc 200 and searches for the startup markup document. In operation 803, a current markup document is interpreted, and it is checked whether the current markup document is correct in grammar, and elements are organized by forming a document object model (DOM) tree. Additionally, the DOM tree observes the following rules: first, a root node of all nodes is set to a document node, and second, all texts and elements form nodes, and third, a processing instruction, a comment, and a document type form nodes.

In operation 804, it is determined whether the multimedia elements other than the text files exist in the markup document. If the multimedia elements exist in the markup document, in operation 805, the current version of the multimedia elements in the tag <META> and the minimum viewer version that can reproduce the multimedia elements are checked. If the multimedia elements do not exist in the markup document, reproducing a current page is performed in operation 808.

In operation 806, it is determined whether the current version of the multimedia elements is higher than the viewer version in the reproducing apparatus. If the current version of the multimedia elements is higher than the viewer version in the reproducing apparatus, determining whether the minimum viewer version is higher than the viewer version in the reproducing apparatus, is performed in operation 807.

If the minimum viewer version that can reproduce the multimedia elements is not higher than the viewer version in the reproducing apparatus in operation 807, the current page is reproduced in operation 808. If the minimum viewer version that can reproduce the multimedia elements is higher than the viewer version in the reproducing apparatus, replacement elements are reproduced in a layout area of corresponding multimedia elements in operation 809. The replacement elements may be implemented in various shapes, such as character messages indicating that the corresponding multimedia elements cannot be reproduced because the minimum viewer version required to reproduce the multimedia elements is higher than the viewer version in the reproducing apparatus, or graphic messages, such as a background screen. The recording and reproducing method of the present invention may be implemented as a computer program. The program is stored in computer readable media, is read and executed by a computer such that the method of recording and reproducing the markup document and the AV data on the information storage medium 200 can be implemented. Suitable computer readable media include magnetic recording media, optical recording media, and carrier wave media.

As described above, according to the present invention, the minimum user agent (UA) version information for interpreting the markup document is included in the markup document such that the reproducing apparatus can display the interactive contents authored using the authoring tool that supports an arbitrary interactive contents version. In addition, in the markup document, the minimum UA version information indicating that the minimum version of a viewer is included in the interactive contents such that the reproducing apparatus can reproduce the multimedia elements smoothly.

While this invention has been particularly shown and described with reference to preferred embodiments thereof, it will be understood by those skilled in the art that various changes in form and details may be made therein without departing from the spirit and scope of the invention as defined by the appended claims and their equivalents thereof.

What is claimed is:

1. A recording method comprising:
recording audio and/or video (AV) data;
recording a markup document defining a display window in which the AV data is displayed on an information storage medium; and
recording minimum markup version information and/or minimum multimedia version information reproducible by a reproducing apparatus.

2. The method of claim 1, wherein:
the recording of the AV data comprises,
recording the AV data in a video directory;
the recording of the markup document comprises,
recording the markup document in an interactive directory; and
the recording of the minimum markup and/or multimedia version information comprises,
recording the minimum markup version information and/or minimum multimedia version information in a reproduction control information file in the interactive directory.

3. The method of claim 1, wherein:
the recording of the AV data comprises,
recording the AV data in a video directory;
the recording of the markup document comprises,
recording the markup document in an interactive directory, and
the recording of the minimum markup and/or multimedia version information comprises,
recording the minimum markup version information in a reproduction control information file in the interactive directory, and the minimum multimedia version information in the markup document.

4. The method of claim 3, wherein the recording of the minimum markup and/or multimedia version information comprises:
recording the multimedia version information in a tag <META> in the markup document.
